(19) United States
(12) Patent Application Publication
(10) Pub. No.: US 2009/0245660 A1
(43) Pub. Date: Oct. 1, 2009

(54) METHOD AND DEVICE FOR CLASSIFYING SAMPLES REPRESENTING A DIGITAL IMAGE SIGNAL

(75) Inventors: Felix Henry, Rennes (FR); Isabelle Corouge, Rennes (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/411,087

(22) Filed: Mar. 25, 2009

(30) Foreign Application Priority Data
Mar. 26, 2008 (FR) 0851924

(51) Int. Cl. G06K 9/62

(52) U.S. Cl. 382/224

(57) ABSTRACT

In order to classify samples representing a digital image signal, for at least one sample the output values of a predetermined set of filters applied to that sample are determined. The sample is then classified in a first region or in a second region according to a measurement representing the dispersion of the output values.

### TECHNICAL FIELD OF THE INVENTION

The present invention relates to a method and device for classifying samples representing a digital image signal.

It belongs to the general field of digital signal processing and more precisely to the classification of samples or segmentation, and to the filtering and compression of digital images.

### BACKGROUND OF THE INVENTION

For example, a digital image coming from a digital photographic apparatus consists of a set of N×M elementary picture units or pixels, where N is the height of the image and M its width. This image is coded before being stored in memory. The initial data, that is to say the information representing the pixels of the image, is organised in a bidimensional table accessible for example line by line.

A digital image generally undergoes a transformation prior to its coding. Likewise, when a coded digital image is decoded, the image undergoes a reverse transformation. The transformation can consist of applying a filter to all or part of the digital image.

A filter can be seen as a convolution product between the image signal and a predetermined vector making it possible, for each pixel of the region to which it is applied, to modify its value according to the value of the neighboring pixels, to which coefficients are allocated.

The coding technique described in the patent document FR-A-2 889 382 makes it possible to filter the signal prior to a compression, by orienting the filter along certain directions, for each pixel, with a view to reducing the dynamic range of the signal generated and thus increasing the compression of the signal.

The main aspects of this filtering, which is used by the present invention in a particular embodiment, are stated below. It is however not impossible for the invention to use another type of transformation, in place of such a filtering.

This filtering, which uses a decompression of the signal into frequency sub-bands, aims to reduce the quantity of information present in the sub-bands so as to improve the compression of the signal with a view to its storage or transmission.

Each filtered sample has an amplitude value and a geometric orientation value. “Orientation” means here a direction in the image (for example row of pixels or column of pixels or diagonal of pixels) or more generally a set of predefined filters.

A filtering is applied along the orientation that will have been determined as the most appropriate, so as to increase the performance of the filtering.

Such a filtering method makes it possible to take account of local variations and in particular the local orientation of the flow of the digital signal whilst preserving the property of separability of the filtering, that is to say the filtering can be applied independently on the different dimensions of the digital signal being processed, for example successively on each of its dimensions, such as, in the case of an image signal, along the rows and along the columns or vice versa.

In order to facilitate the reverse filtering operation performed on decoding, it is possible to associate, during coding, with each filtered sample, information representing the geometric orientation of the filter applied to this sample.

The filtering of samples can use a filtering scheme that is particularly advantageous for the present invention, called a lifting scheme, with for example at least two filters, which can each be applied to different samples, which is economical in terms of memory space, given that the samples are replaced during their filtering.

The lifting scheme is a particular implementation of wavelet transformation that performs two successive filterings, a first high-pass filtering and a second low-pass filtering, each sample being replaced by the result of its filtering.

For example, the lifting scheme performs a first pass by selecting the samples having an even position, with a view to their filtering according to a high-pass filter and their replacement. Next, the lifting scheme makes a second pass by selecting the samples having an odd position with a view to their filtering according to a low-pass filter and their replacement. The high-pass samples are generated using solely samples of odd rank and the sample to be filtered, and then the low-pass filters are generated using solely the sample to be filtered and the samples of even rank (that is to say the samples generated during the high-pass filtering step).

As for the decoding of a digital signal coded by such a technique, it consists mainly of obtaining a plurality of filtered samples and then applying a reverse filtering to filtered samples, this reverse filtering being performed on a filtered sample according to the geometric orientation of the filter that was used for the filtering of this sample during its coding according to the invention.

Document U.S. Pat. No. 5,617,459 describes a method of forming a gradient image with the elimination of the non-maximum gradients for the purpose of sub-sampling an image while keeping the strong contours of the initial image in the sub-sampled version. An oriented gradient filter is applied in order to select locally the direction in which the gradient is at a maximum. Along this direction, a small neighborhood of the current pixel is defined within which the pixel having the maximum gradient is segmented.

### SUMMARY OF THE INVENTION

The aim of the present invention is to increase the compression ratio of the image for equivalent quality, or conversely to improve the quality of the image for an equal compression ratio. For this purpose, the invention seeks to classify the samples representing the signal with a view to applying a differentiated compression treatment between the various classes.

For this purpose, the present invention proposes a method of classifying samples representing a digital image signal, remarkable in that, for at least one sample:

the output values of a predetermined set of filters applied to this sample are determined; and

this sample is classified in a first region or in a second region according to a measurement representing the dispersion of these values.

Thus the invention makes it possible to reduce the rate of the signal carrying the information on the choice of the type of filtering. The invention consequently makes it possible to increase the compression ratio of the images while maintaining their quality and, for a given compression ratio, to improve the quality of the images.

In a particular embodiment, the method also comprises a step consisting of applying a predetermined filter to the samples of the second region.

The use of a single filter for this second region reduces the signal transmission cost.

In a particular embodiment, the method also comprises a step consisting of applying to each sample of the first region a filter determined for this sample according to a predefined criterion.

In this way the quality of the signal for this first region is improved.

In a particular embodiment, the classification step consists of comparing the dispersion measurement with a threshold and, for the samples of the first region, the dispersion measurement is above the threshold.

The comparison with a threshold constitutes a technique that is effective and simple to implement.

In a particular embodiment, the dispersion measurement is the difference in absolute value between the maximum value and the minimum value of the aforementioned output values.

In a variant, the dispersion measurement is the difference in absolute value between the maximum value and the mean value of the aforementioned output values.

In another variant, the dispersion measurement is the variance of all the aforementioned output values.

These three calculation modes represent simple and effective alternatives for obtaining a measurement of the dispersion of the output values of the filters.

In a particular embodiment, the filters of the aforementioned predetermined set of filters are chosen from a set of filters oriented according to a plurality of geometric orientations.

This category of filter is particularly well adapted to increasing the compression of the signal.

In a particular embodiment, the predefined criterion consists of minimizing the sum of the amplitudes of the output samples of the filters according to the various orientations.

This is an optimal criterion for determining the adapted filter for each sample.

For the same purpose as that indicated above, the present invention also proposes a device for classifying samples representing a digital image signal, remarkable in that it comprises:

a module for determining, for at least one sample, the output values of a predetermined set of filters applied to this sample; and

a module for classifying this sample in a first region or in a second region according to a measurement representing the dispersion of these values.

Still for the same purpose, the present invention also relates to a telecommunication system comprising a plurality of terminal devices connected through a telecommunication network, remarkable in that it comprises at least one terminal device equipped with a classification device as succinctly described above.

Still for the same purpose, the present invention also relates to an information storage means that can be read by a computer or a microprocessor storing instructions of a computer program, remarkable in that it allows the implementation of a classification method as succinctly described above.

Still for the same purpose, the present invention also relates to a computer program product able to be loaded into a programmable apparatus, remarkable in that it comprises sequences of instructions for implementing a classification method as succinctly described above, when this program is loaded into and run by the programmable apparatus.

The particular characteristics and the advantages of the classification device, of the telecommunication system, of the information storage means and of the computer program product being similar to those of the classification method, they are not repeated here.

### BRIEF DESCRIPTION OF THE DRAWINGS

Other aspects and advantages of the invention will emerge from a reading of the following detailed description of particular embodiments, given by way of non-limiting examples. The description refers to the drawings that accompany it, in which:

FIG. 1 shows in a simplified manner a digital image processing system able to implement a classification method according to the present invention;

FIG. 2 is a flow diagram illustrating the main steps of a classification method according to the present invention, in a particular embodiment;

FIG. 3 illustrates an example of filtering according to several geometric orientations, able to be used by the method according to the present invention, in a particular embodiment; and

FIG. 4 depicts schematically a particular embodiment of an apparatus able to implement the present invention.

### DETAILED DESCRIPTION OF PARTICULAR EMBODIMENTS

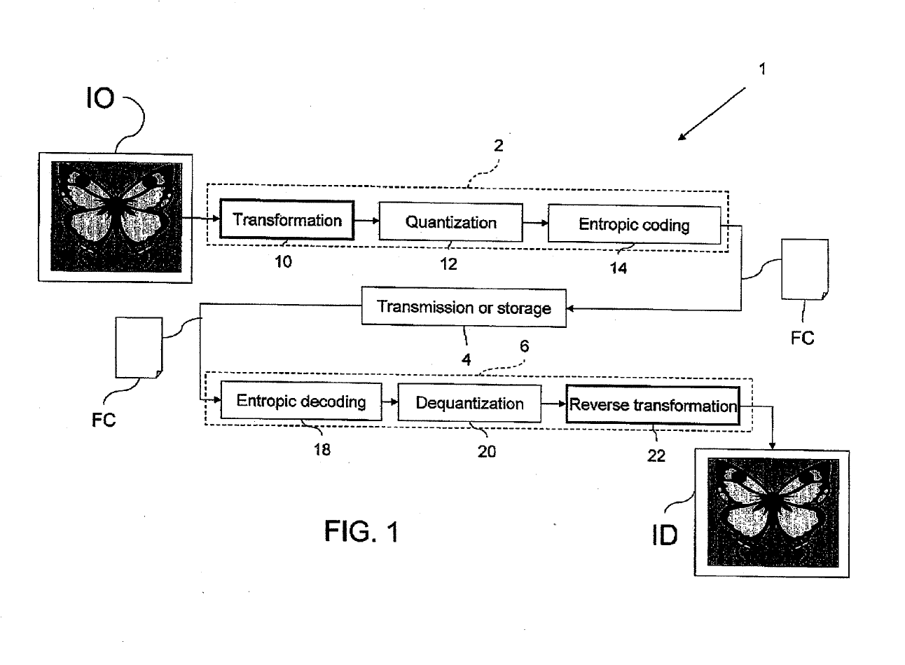

The block diagram of FIG. 1 illustrates a system for processing digital images in particular by coding and decoding involving a classification according to the invention, this system being designated by the general reference denoted 1.

The system comprises a coding device 2, a transmission or storage unit 4 and a decoding device 6.

The invention finds a particularly advantageous application in a telecommunication system comprising a plurality of terminal devices connected through a telecommunication network. The coding method according to the invention can be implemented in terminal devices of the system, so as to allow a transmission of files over the telecommunication network and thus reduce the traffic and transmission times.

Another particularly advantageous application consists of using the classification method according to the invention in a multimedia entity storage device so as to be able to store a large quantity of data in a storage unit.

As shown by FIG. 1, the coding device 2 according to the invention receives an original image IO as an input. The image IO is processed by the coding device 2, which delivers as an output a coded file containing compressed image data, designated by the reference sign FC.

The processing carried out in the coding device 2 consists of performing transformation, quantization and entropic coding operations respectively in the units 10, 12 and 14.

The transformation operation performed in the unit 10 is that which implements the invention, while the quantization and entropic coding operations respectively performed in the units 12 and 14 use conventional means.

The coded file FC is supplied to the transmission or storage unit 4 so as for example to be transmitted over the network or stored in a storage unit such as a CD, a DVD or a hard disk.

The decoding device 6 receives as an input the coded file FC coming from the transmission or storage unit 4 and supplies as an output a decoded (or decompressed) image ID, which represents the original image IO degraded by the coding error.

On decoding, the coded image is successively subjected to entropic decoding, dequantization and reverse transformation operations respectively in the units 18, 20 and 22.

The reverse transformation operation performed in the unit 22 does not relate to the invention and the entropic decoding and dequantization steps respectively performed in the units 18 and 20 use conventional means.

Generally the initial data corresponding to the original image IO is organized in a bidimensional table.

The particular embodiment described below presents the classification of the samples of a fixed digital image, that is to say of a bidimensional signal. The principle is however identical for a signal having a greater number of dimensions, for example for a video, which is composed of three dimensions.

In this particular embodiment, the classification is followed by a special filtering. This special filtering consists of decomposing the digital image signal into frequency sub-bands.

In the particular embodiment of invention described in detail below, this type of filtering in sub-bands is used for compressing the digital image. Such a filtering is similar to that used in the JPEG2000 standard, during an operation also referred to as wavelet decomposition.

For more details on the JPEG2000 standard, reference can usefully be made to the following internet address: www.jpeg.org.

However, the present invention differs from the filtering as used in JPEG2000 since the filters used can be oriented, as described in the patent document FR-A-2 889 382.

In the document FR-A-2 889 382, the information on the orientation of the filtering of a sample, once determined by optimization of the output of the filtering, is transmitted to the decoder.

In a particular embodiment, the present invention proposes to orient the filter only if the orientation information is advantageous in terms of compression ratio. For this purpose, it produces a classification or binary segmentation of the sub-band to be decomposed: the image is segmented in a first region for the pixels of which the orientation information is pertinent and the second region for the pixels of which this information is not pertinent.

Thus the method of determining the orientation according to the invention differs from that used in the document FR-A-2 889 382 for determining the optimal orientation. This is because, in accordance with the present invention, an optimal orientation is sought only for the pixels of the aforementioned first region and a predetermined (default) orientation is attributed to the pixels of the second region.

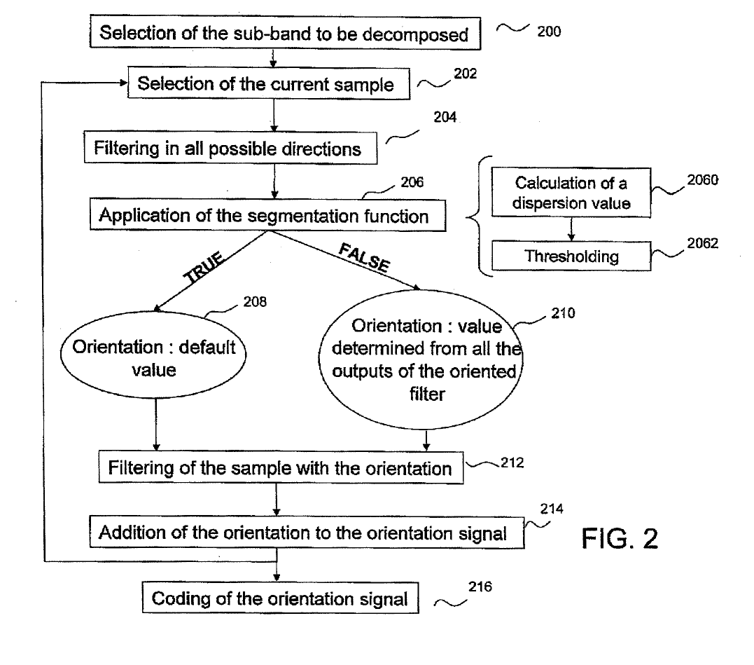

The flow diagram of FIG. 2 illustrates the essential steps of the process of classification and application of the classification to the oriented filtering in a particular embodiment.

A filtering in sub-bands consists of applying a filtering to an initial signal in order to generate one or more sub-bands corresponding to different frequencies. All these sub-bands correspond to a given resolution. It is then usual to select one or more of the sub-bands in order once again to decompose them into sub-bands, which will constitute the following resolution. This process can be iterated a certain number of times.

The way in which the classification and filtering of a single sub-band is carried out is described below.

First of all, during a step 200, the initial image is selected and considered as a sub-band to be filtered. In a variant, a sub-band already produced can be selected as a sub-band to be decomposed.

Then at step 202 the sample to be filtered is selected. Given a sub-band to be decomposed, the horizontal and vertical dimensions are filtered sequentially. The samples to be filtered on the dimension in question are determined by the parity information carried by the filter to be oriented and are also processed sequentially. The filter to be oriented may for example be a high-pass filter extracting the high frequencies of the signal. The current sample, denoted P, is selected from the samples not yet processed.

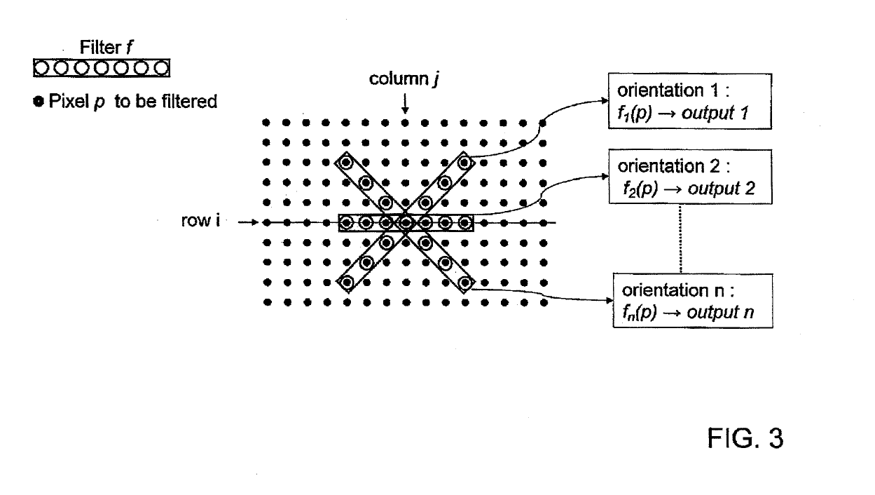

The following step 204 is illustrated by FIG. 3. The filter to be oriented is applied to the current sample according to all its predefined orientations.

Let n be the number of predefined orientations and F={fᵢ, i=1 . . . , n} all the filtering functions, where fᵢ corresponds to the application of the filter to be oriented according to the i^{th} orientation. The application to the current sample p of the filtering in all the possible directions produces a set of output values V={f₁(p), . . . , fₙ(p)}.

As shown by FIG. 2, during the following step 206, the current pixel p is segmented, that is to say classified, either in a first region for which orienting the filter is pertinent or in a second region for which orienting the filter is not pertinent.

In order to carry out this classification or segmentation, a quantity representing the dispersion of the values of the set V is measured during a step 2060 and is compared with a threshold at step 2062.

Let Class be the Boolean classification function, Disp the function measuring the dispersion and t the threshold. Class(p)=(Disp(p)<t). In other words, if Class(p) is true then the current pixel belongs to the second region and otherwise it belongs to the first region.

It is possible to choose from several definitions of the measurement taking account of the dispersion of the values of V. By way of non-exhaustive and in no way limiting examples, the measurement of the dispersion can be taken to be equal to:
the difference, in absolute value, between the maximum value and the minimum value of V, that is to say Disp(p)=|fₘₐₓ(p)−fₘᵢₙ(P|); or
the difference, in absolute value, between the maximum value and mean value of the elements of V, that is to say

$$Disp ( p ) = \vert {f}_{max} ( p ) - \frac{1}{n} {\sum }_{i = 1}^{n} {f}_{i} ( p ) \vert ;$$

or again
the variance of all the elements of V.

For step 2062 of comparison with a threshold, the choice of the threshold t falls to the user. It can be fixed a priori at a predetermined value, for example 7, or chosen interactively. If the threshold t is fixed at 0 then it is certain that only the samples for which the orientation in no way modifies the output value of the filter will be allocated to the second region.

In a variant embodiment, the classification is used for carrying out a labeling of the samples of an image, for example in order to differentiate distinct types of cultivation in aerial photographs of areas of vegetation. Thus the invention has various direct applications of the classification, without needing to have the classification steps followed by any filtering process.

On the other hand, in the particular embodiment described here, steps 208 and 210 follow the classification.

Step 208 consists of attributing a default orientation to the samples of the second region, for example the orientation 0, in all cases always the same for all the samples of the second region.

On the other hand, the samples of the first region have an orientation determined from the set V of output values of the oriented filter attributed to them. For example, the orientation considered to be optimal will be the one corresponding to the minimum value among the elements of the set V.

Next, step 212 consists of filtering the current sample by the oriented filter according to the orientation determined previously at the end of step 208 or 210.

During a step 214, the orientation signal (that is the say the signal transporting the information on the orientation of the filtering) is next incremented with the previously determined orientation that was used for filtering the current sample.

Once all the samples to be filtered in the sub-band to be decomposed have been processed and the associated orientations have been determined and assembled in order to form the orientation signal, the orientation signal is coded at step 216, by conventional means.

The distribution of the orientations within the orientation signal is modified because of the increase in the frequency of the orientation attributed to the samples of the second region, for which orientating the filter is not pertinent. The invention thereby makes it possible to decrease the entropy of the orientation signal and therefore to reduce its rate.

Moreover, no increase in the rate is caused by the classification process since it is not necessary to explicitly transmit from the coder to the decoder the segmentation mask produced during the classification of the pixels of the image in the first and second regions.

This is because the classification is used in order to modify the orientation signal which, for its part, is transmitted to the decoder. More precisely, by assigning the same predetermined orientation to all the pixels indifferent to orientation, the statistic of the orientation signal is modified and its rate reduced.

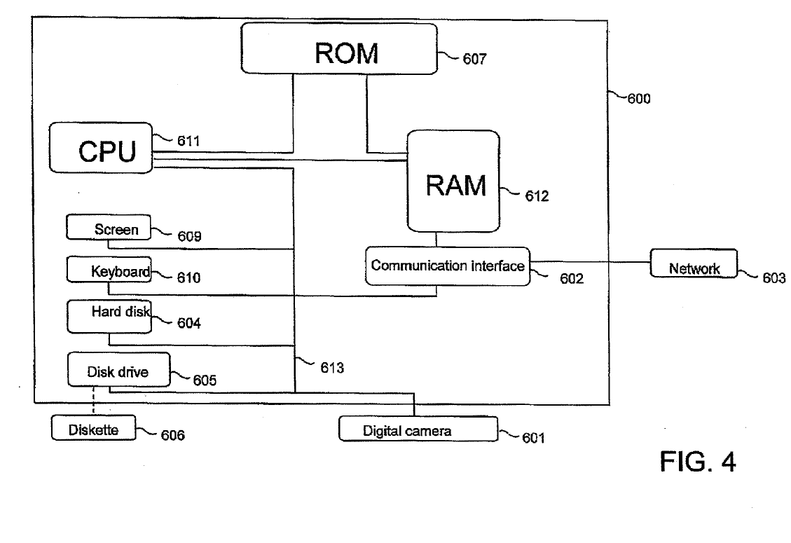

FIG. 4 shows a particular embodiment of an information processing device able to function as a device for classifying a digital signal according to the present invention.

The device illustrated in FIG. 4 can comprise all or some of the means of implementing a classification method according to the present invention.

According to the embodiment chosen, this device may for example be a microcomputer or a workstation 600 connected to various peripherals, for example a digital camera 601 (or a scanner or any other image acquisition or storage means) connected to a graphics card (not shown) and thus providing information to be processed according to the invention.

The microcomputer 600 preferably comprises a communication interface 602 connected to a network 603 able to transmit digital information. The microcomputer 600 also comprises a permanent storage means 604 such as a hard disk, as well a reader for temporary storage means such as a disk drive 605 for cooperating with a diskette 606.

The diskette 606 and the hard disk 604 can contain software implantation data of the invention as well as the code of the computer program or programs whose execution by the microcomputer 600 implements the present invention, this code being for example stored on the hard disk 604 once it has been read by the microcomputer 600.

In a variant, the program or programs enabling the device 600 to implement the invention are stored in a read only memory (for example of the ROM type) 607.

According to another variant, this program or programs are received totally or partially over the communication network 603 in order to be stored as indicated.

The microcomputer 600 also comprises a screen 609 for displaying the information to be processed and/or serving as an interface with the user, so that the user can for example parameterize certain processing modes by means of the keyboard 610 or any other suitable pointing and/or entry means such as a mouse, an optical pen, etc.

A calculation unit or central processing unit (CPU) 611 executes the instructions relating to the implementation of the invention, these instructions being stored in the read only memory ROM 607 or in the other storage elements described.

When the device 600 is powered up, the processing programs and methods stored in one of the non-volatile memories, for example the ROM 607, are transferred into a random access memory (for example of the RAM type) 612, which then contains the executable code of the invention as well as the variables necessary for implementing the invention.

In a variant, the methods of processing the digital signal can be stored in various storage locations. In general terms, an information storage means that can be read by a computer or by a microprocessor, integrated or not in the device, possibly removable, can store one or more programs whose execution implements the classification method described previously.

The particular embodiment chosen for the invention can be developed, for example by adding updated or enhanced processing methods; in such a case, these new methods can be transmitted to the device 600 by the communication network 603, or loaded into the device 600 by means of one or more diskettes 606. Naturally the diskettes 606 can be replaced by any information carrier deemed appropriate (CD-ROM, memory card, etc).

A communication bus 613 affords communication between the various elements of the microcomputer 600 and the elements connected to it. It should be noted that the representation of the bus 613 is not limiting. This is because the central processing unit CPU 611 is for example able to communicate instructions to any element of the microcomputer 600, directly or by means of another element of the microcomputer 600.

We claim:

1. A method of classifying samples representing a digital image signal, comprising steps consisting, for at least one sample, of:
determining the output values of a predetermined set of filters applied to said sample; and
classifying said sample in a first region or in a second region according to a measurement representing the dispersion of said values.

2. A method according to claim 1, also comprising a step consisting of applying a predetermined filter to the samples of said second region.

3. A method according to claim 1, also comprising a step consisting of applying to each sample of said first region a filter determined for this sample according to a predefined criterion.

4. A method according to claim 3, wherein said classifying step consists of comparing said dispersion measurement with a threshold and wherein, for the samples of the first region, said dispersion measurement is greater than said threshold.

5. A method according to claim 1, wherein said dispersion measurement is the difference in absolute value between the maximum value and the minimum value of said output values.

6. A method according to claim 1, wherein said dispersion measurement is the difference in absolute value between the maximum value and the mean value of said output values.

7. A method according to claim 1, wherein said dispersion measurement is the variance of all of said output values.

8. A method according to claim 3, wherein the filters of said predetermined set of filters are chosen from a set of filters oriented according to a plurality of geometric orientations.

9. A method according to claim 8, wherein said predefined criterion consists of minimizing the sum of the amplitudes of the output samples of the filters according to the various orientations.

10. A device for classifying samples representing a digital image signal, said device comprising:
means for determining, for at least one sample, the output values of a predetermined set of filters applied to said sample; and
means for classifying said sample in a first region or in a second region according to a measurement representing the dispersion of said values.

11. A device according to claim 10, also comprising means for applying a predetermined filter to the samples of said second region.

12. A device according to claim 10, also comprising means for applying to each sample of said first region a filter determined for this sample according to a predefined criterion.

13. A device according to claim 12, wherein said classifying means are adapted to compare said dispersion measurement with a threshold and wherein, for the samples of the first region, said dispersion measurement is greater than said threshold.

14. A device according to claim 10, wherein said dispersion measurement is the difference in absolute value between the maximum value and the minimum value of said output values.

15. A device according to claim 10, wherein said dispersion measurement is the difference in absolute value between the maximum value and the mean value of said output values.

16. A device according to claim 10, wherein said dispersion measurement is the variance of all of said output values.

17. A device according to claim 12, wherein the filters of said predetermined set of filters are chosen from a set of filters oriented according to a plurality of geometric orientations.

18. A device according to claim 17, wherein said predefined criterion consists of minimizing the sum of the amplitudes of the output samples of the filters according to the various orientations.

19. A telecommunication system comprising a plurality of terminal devices connected through a telecommunications network, said telecommunication system comprising at least one terminal device equipped with a classifying device according to claim 10.

20. An information storage means that can be read by a computer or a microprocessor storing instructions of a computer program, wherein said information storage means allows the implementation of a classifying method according to claim 1.

21. A computer program product able to be loaded into a programmable apparatus, wherein said program contains sequences of instructions for implementing a classifying method according to claim 1, when said program is loaded into and run by the programmable apparatus.
